(19) United States
(12) Patent Application Publication
(10) Pub. No.: US 2009/0036599 A1
(43) Pub. Date: Feb. 5, 2009

(54) POWDERY THREE-DIMENSIONALLY CROSSLINKED CLATHRATE PARTICLE, PROCESS OF PRODUCING SAME, DISPERSION, AND RESIN COMPOSITION

(75) Inventors: Hideo Sawada, Aomori (JP); Masashi Sugiya, Tokyo (JP); Ryo Ebara, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignees: NIPPON CHEMICAL INDUSTRIAL CO., LTD., Tokyo (JP); NATIONAL UNIVERSITY CORPORATION HIROSAKI UNIVERSITY, Hirosaki-shi, Aomori (JP)

(21) Appl. No.: 12/293,949

(22) PCT Filed: Mar. 16, 2007
(86) PCT No.: PCT/JP2007/055406

§ 371 Date: Sep. 22, 2008

(30) Foreign Application Priority Data
Mar. 24, 2006 (JP) 2006-083273

(51) Int. Cl. C08L 75/14; C08G 18/71

(52) U.S. Cl. 524/590; 528/69

(57) ABSTRACT

A material enabling uniformly dispersing an ionic liquid or a phosphonium salt in various solvents or resin materials is provided. The material is powdery particles of a three-dimensionally crosslinked clathrate obtained by a process including a first-order polymerization step in which a fluoroalkanoyl peroxide compound, a monofunctional monomer, and a polyfunctional monomer having an olefinic double bond and an isocyanate group are reacted to one another to obtain a fluoroalkyl-containing cooligomer and a crosslinking step including the substeps of mixing the fluoroalkyl-containing cooligomer and an ionic liquid or a phosphonium salt and causing the cooligomer to react with itself at the isocyanate groups thereof in the presence of the ionic liquid or the phosphonium salt to obtain powdery three-dimensionally crosslinked clathrate particles.

### TECHNICAL FIELD

This invention relates to powdery particles of a three-dimensionally crosslinked clathrate having an ionic liquid or a phosphonium salt trapped therein, a dispersion of the powdery three-dimensionally crosslinked clathrate particles, and a resin composition containing the powdery three-dimensionally crosslinked clathrate particles.

### BACKGROUND ART

An ionic liquid is a salt formed between a cation and an anion. It is liquid at ambient temperature and pressure and has no boiling point. Some ionic liquids have been studied from the early twentieth century for possible use in the field of electrochemistry but not for other applications.

With the increasing call for “green chemistry” in the 1990s, ionic liquids have been attracting attention because of their interesting properties such as incombustibility and nonvolatility. A variety of ionic liquids have thus been developed. In recent years, research has been progressing on the use of ionic liquids as incombustible, nonvolatile, and highly polar solvents.

However, applications of an ionic liquid other than as a solvent have not been developed. Development of a novel use of an ionic liquid is awaited.

A phosphonium salt represented by general formula (3):

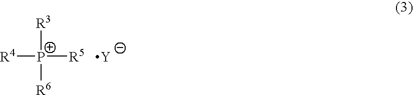

(wherein R³, R⁴, R⁵, and R⁶, which may be the same or different, each represent a straight-chain or branched alkyl group having 1 to 18 carbon atoms, a cycloalkyl group, or a phenyl group; and Y represents an anion group)
   has antistatic properties and antimicrobial properties and is therefore useful as an antistatic agent or an antimicrobial agent. The phosphonium salt of general formula (3) also finds use as a reaction catalyst. Some of the phosphonium salts of general formula (3) are liquid and others solid at ambient temperature and pressure.

### DISCLOSURE OF THE INVENTION

### Problem to be Solved by the Invention

A functional material containing an ionic liquid is one of conceivable novel uses of an ionic liquid. An ionic liquid must be dispersed uniformly in a solvent, a resin material, etc. before an ionic liquid-containing functional material can be produced. The problem is that an ionic liquid, being liquid, is extremely difficult to disperse uniformly in a solvent, a resin material, etc.

Similarly to an ionic liquid, a functional material containing the phosphonium salt of general formula (3) is one of conceivable novel uses of the phosphonium salt. The phosphonium salt of general formula (3) must be dispersed uniformly in a solvent, a resin material, etc. before a functional material containing the phosphonium salt can be produced. The problem is that the phosphonium salts of general formula (3) which exhibit the ionic liquid property of being liquid at ambient temperature and pressure are extremely difficult to disperse uniformly in a solvent, a resin material, etc. similarly to an ionic liquid. On the other hand, the phosphonium salts of general formula (3) which are solid at ambient temperature and pressure are generally not only difficult to reduce to fine particles but also liable to agglomerate in a dispersion. Therefore, when they are dispersed in various solvents, resin materials, etc., the resulting dispersions tend to suffer from non-uniformity.

Accordingly, an object of the invention is to provide a substance enabling uniformly dispersing an ionic liquid or a phosphonium salt of general formula (3) in various solvents, resin materials, and the like.

### Means for Solving the Problem

To solve the above described problems of conventional techniques, the present inventors have conducted extensive study. As a result, they have reached the following findings and completed the present invention. When a specific fluoroalkanoyl peroxide compound, a specific monofunctional monomer, and a polyfunctional monomer having an isocyanate group are caused to react with one another to form an oligomer, which is then crosslinked with itself at the isocyanate group thereof to make a three-dimensional crosslinked structure, presence of an ionic liquid or the phosphonium salt in the crosslinking reaction system results in the formation of a three-dimensionally crosslinked clathrate compound having the ionic liquid or the phosphonium salt enclathrated in the cavities thereof.

The invention provides:

(1) A powdery particle of a three-dimensionally crosslinked clathrate that is obtained by a process including a first-order polymerization step and a crosslinking step. The first-order polymerization step is a step of causing a fluoroalkanoyl peroxide compound represented by general formula (1):

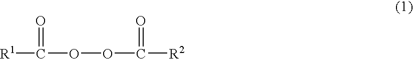

(wherein R¹ and R², which may be the same or different, each represent a —(CF₂)ₚ—X group or a —CF(CF₃)—[OCF₂CF(CF₃)]_{q}—OC₃F₇ group; X represents a hydrogen atom, a fluorine atom or a chlorine atom; and p and q each represents an integer of 0 to 10)
   a monofunctional monomer represented by general formula (2):

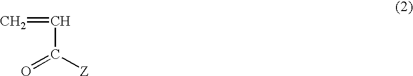

(wherein Z represents a hydroxyl group, a morpholino group, a tertiary amino group, or a secondary amino group)
   and a polyfunctional monomer having an olefinic double bond and an isocyanate group to react to obtain a fluoroalkyl-containing cooligomer. The crosslinking step comprises the substeps of mixing the fluoroalkyl-containing cooligomer and an ionic liquid and causing the cooligomer to react with itself at the isocyanate groups thereof in the presence of the ionic liquid to obtain a three-dimensionally crosslinked clathrate in the form of powdery particles.
   (2) A powdery particle of a three-dimensionally crosslinked clathrate that is obtained by a process including a first-order polymerization step and a crosslinking step. The first-order polymerization step is a step of causing a fluoroalkanoyl peroxide compound represented by general formula (1):

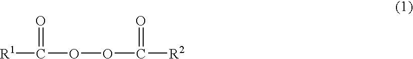

(wherein R¹ and R², which may be the same or different, each represent a —(CF₂)ₚ—X group or a —CF(CF₃)—[OCF₂CF(CF₃)]_{q}—OC₃F₇ group; X represents a hydrogen atom, a fluorine atom or a chlorine atom; and p and q each represents an integer of 0 to 10)
   a monofunctional monomer represented by general formula (2):

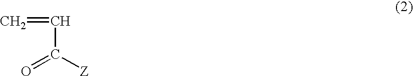

(wherein Z represents a hydroxyl group, a morpholino group, a tertiary amino group, or a secondary amino group)
   and a polyfunctional monomer having an olefinic double bond and an isocyanate group to react to obtain a fluoroalkyl-containing cooligomer. The crosslinking step comprises the substeps of mixing the fluoroalkyl-containing cooligomer and a phosphonium salt represented by general formula (3):

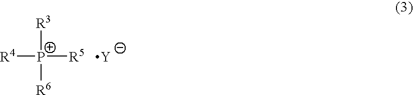

(wherein R³, R⁴, R⁵, and R⁶, which may be the same or different, each represent a straight-chain or branched alkyl group having 1 to 18 carbon atoms, a cycloalkyl group, or a phenyl group; and Y represents an anion group)
   and causing the cooligomer to react with itself at the isocyanate groups thereof in the presence of the phosphonium salt represented by general formula (3) to obtain a three-dimensionally crosslinked clathrate in the form of powdery particles.
   (3) A process of producing a powdery particle of a three-dimensionally crosslinked clathrate. The process includes a first-order polymerization step and a crosslinking step. The first-order polymerization step is a step of causing a fluoroalkanoyl peroxide compound represented by general formula (1):

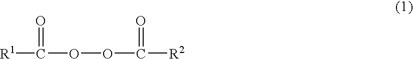

(wherein R¹ and R², which may be the same or different, each represent a —(CF₂)ₚ—X group or a —CF(CF₃)—[OCF₂CF(CF₃)]_{q}—OC₃F₇ group; X represents a hydrogen atom, a fluorine atom or a chlorine atom; and p and q each represents an integer of 0 to 10)
   a monofunctional monomer represented by general formula (2):

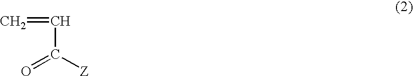

(wherein Z represents a hydroxyl group, a morpholino group, a tertiary amino group, or a secondary amino group)
   and a polyfunctional monomer having an olefinic double bond and an isocyanate group to react with one another to obtain a fluoroalkyl-containing cooligomer. The crosslinking step comprises the substeps of mixing the fluoroalkyl-containing cooligomer and an ionic liquid and causing the cooligomer to react with itself at the isocyanate groups thereof in the presence of the ionic liquid to obtain a three-dimensionally crosslinked clathrate in the form of powdery particles.
   (4) A process of producing a powdery particle of a three-dimensionally crosslinked clathrate. The process includes a first-order polymerization step and a crosslinking step. The first-order polymerization step is a step of causing a fluoroalkanoyl peroxide compound represented by general formula (1):

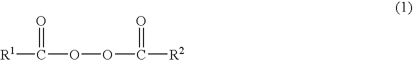

(wherein R¹ and R², which may be the same or different, each represent a —(CF₂)ₚ—X group or a —CF(CF₃)—[OCF₂CF(CF₃)]_{q}—OC₃F₇ group; X represents a hydrogen atom, a fluorine atom, or a chlorine atom; and p and q each represents an integer of 0 to 10)
   a monofunctional monomer represented by general formula (2):

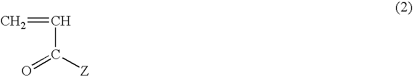

(wherein Z represents a hydroxyl group, a morpholino group, a tertiary amino group, or a secondary amino group)
   and a polyfunctional monomer having an olefinic double bond and an isocyanate group to react with one another to obtain a fluoroalkyl-containing cooligomer. The crosslinking step comprises the substeps of mixing the fluoroalkyl-containing cooligomer and a phosphonium salt represented by general formula (3):

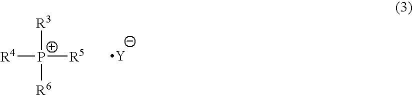

(wherein R³, R⁴, R⁵, and R⁶, which may be the same or different, each represent a straight-chain or branched alkyl group having 1 to 18 carbon atoms, a cycloalkyl group, or a phenyl group; and Y represents an anion group)
   and causing the cooligomer to react with itself at the isocyanate groups thereof in the presence of the phosphonium salt of general formula (3) to obtain a three-dimensionally crosslinked clathrate in the form of powdery particles.
   (5) A dispersion comprising a solvent and the powdery particles of a three-dimensionally crosslinked clathrate described in (1) or (2) above dispersed in the solvent.
   (6) A resin composition containing the powdery particles of a three-dimensionally crosslinked clathrate described in (1) or (2) above.

### BEST MODE FOR CARRYING OUT THE INVENTION

A first embodiment of the powdery particle of a three-dimensionally crosslinked clathrate (hereinafter referred to as a powdery three-dimensionally crosslinked clathrate particle) according to the present invention is a particle obtained by a process including a first-order polymerization step and a crosslinking step. The first-order polymerization step is a step of reacting a fluoroalkanoyl peroxide compound represented by general formula (1), a monofunctional monomer represented by general formula (2), and a polyfunctional monomer having an olefinic double bond and an isocyanate group to obtain a fluoroalkyl-containing cooligomer. The crosslinking step includes the substeps of mixing the fluoroalkyl-containing cooligomer and an ionic liquid and causing the cooligomer to react with itself at the isocyanate groups thereof in the presence of the ionic liquid to obtain a powdery three-dimensionally crosslinked clathrate particle.

The first embodiment of the powdery three-dimensionally crosslinked clathrate particle will be described with reference to an example in which the polyfunctional monomer having an olefinic double bond and an isocyanate group is 2-isocyanatoethyl acrylate.

A fluoroalkanoyl peroxide compound of general formula (1), a monofunctional monomer of general formula (2), and 2-isocyanatoethyl acrylate (4) are mixed in a solvent. The mixture is heated to 45° C. while stirring in a nitrogen atmosphere for 1 to 1.5 hours to cause a reaction to afford a fluoroalkyl-containing cooligomer (5) (first-order polymerization step, see chemical formula (6) below). The fluoroalkyl-containing cooligomer (5) has R¹ and R² at the terminals thereof and has a copolymer main chain comprising the monofunctional monomer of general formula (2) and 2-isocyanatoethyl acrylate.

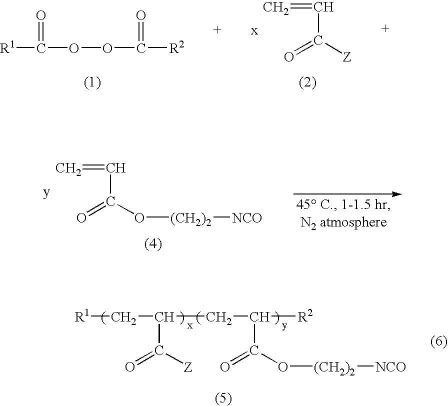

In the first-order polymerization step, heating the mixture of the fluoroalkanoyl peroxide compound of general formula (1), the monofunctional monomer of general formula (2), and 2-isocyanatoethyl acrylate (4) makes the fluoroalkanoyl peroxide compound (1) act as a polymerization initiator, thereby causing the monofunctional monomer (2) and 2-isocyanatoethyl acrylate (4) to copolymerize.

After the first-order polymerization step, an ionic liquid (7) is mixed into the reaction solution containing the fluoroalkyl-containing cooligomer (5). Water and ethylene glycol are further added thereto. The resulting mixture is stirred at 45° C. for 2 hours in a nitrogen atmosphere to cause the fluoroalkyl-containing cooligomer (5) to crosslink with itself at its isocyanate groups, thereby to produce a three-dimensionally crosslinked clathrate (8) in the form of powdery particles (see reaction formula (9) below).

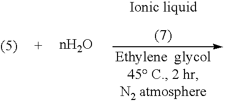

Powdery three-dimensionally crosslinked clathrate particle (8)+nCO₂ (9)

An isocyanate group is a functional group that condenses with another isocyanate group in the presence of a water molecule (H₂O) to form a urea linkage. Reaction formula (12) below illustrates the reaction between isocyanate groups in the presence of a water molecule.

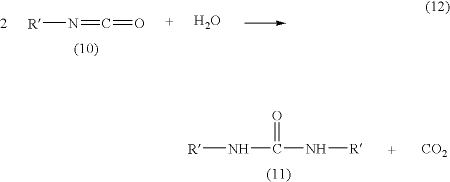

As shown in reaction formula (12), reaction between an isocyanate group of a molecule of an isocyanate compound (10) and an isocyanate group of another molecule of the isocyanate compound (10) in the presence of a water molecule results in condensation between the two molecules of the isocyanate compound (10) while forming a urea linkage therebetween and releasing CO₂ (decarbonation). A condensate (11) in which R′ and another R′ are linked via a urea linkage is thus produced by this condensation reaction.

Now back to the crosslinking step in the production of the first embodiment of the powdery three-dimensionally crosslinked clathrate particle of the invention, isocyanate groups of the fluoroalkyl-containing cooligomer molecules (5) react with each other in the presence of water molecules to link the main chain of a molecule of the fluoroalkyl-containing cooligomer (5) with the main chain of another molecule of the fluoroalkyl-containing cooligomer (5) via a urea linkage.

Because the fluoroalkyl-containing cooligomer (5) has a number of isocyanate groups per molecule, one molecule and another molecule of the fluoroalkyl-containing cooligomer form a plurality of urea linkages therebetween. Namely, two molecules of the fluoroalkyl-containing cooligomer form linkages at a plurality of sites. Furthermore, one molecule of the fluoroalkyl-containing cooligomer forms urea linkages with a plurality of other molecules of the fluoroalkyl-containing cooligomer. Namely, one molecule of the fluoroalkyl-containing cooligomer forms linkages with a plurality of surrounding molecules of the fluoroalkyl-containing cooligomer. In that way, the crosslinking step affords a three-dimensional crosslinked structure.

The three-dimensional crosslinked structure formed by the reaction between the isocyanate groups of the fluoroalkyl-containing cooligomer molecules (5) will be described with reference to FIG. 1. FIG. 1 presents a schematic illustration of a three-dimensional crosslinked structure pertinent to the powdery three-dimensionally crosslinked clathrate particle of the first embodiment of the invention. The three-dimensional crosslinked structure 21 comprises main chains 22 of the fluoroalkyl-containing cooligomer molecules and crosslinkages 23 linking the main chains 22. The individual crosslinkages 23 are urea linkages formed by the reaction between two isocyanate groups of different fluoroalkyl-containing cooligomer molecules. The structure of the individual crosslinkages 23 is represented by formula (13):

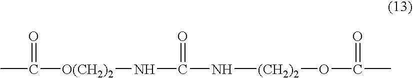

The terminals of the structure of formula (13) are bonded to the main chain 22 of the fluoroalkyl-containing cooligomer. The main chain 22b of a molecule of the fluoroalkyl-containing cooligomer is linked to the main chain 22a of another fluoroalkyl-containing cooligomer molecule through crosslinkages 23a and 23b. The main chain 22b of the fluoroalkyl-containing cooligomer is linked to the main chains 22a and 22c of surrounding fluoroalkyl-containing cooligomer molecules. As a result, the main chains 22a and 22b of the fluoroalkyl-containing cooligomer and the crosslinkages 23a and 23b form a lattice providing a cavity 24a. In the same way, the main chains 22b and 22c of the fluoroalkyl-containing cooligomer and the crosslinkages 23c and 23d form a lattice providing a cavity 24b. Although the crosslinked structure is depicted in two dimensions in FIG. 1 for the sake of simplicity, the crosslinked structure of the powdery three-dimensionally crosslinked clathrate particle of the first embodiment is a three-dimensional structure. The powdery three-dimensionally crosslinked clathrate particle of the first embodiment has an ionic liquid enclathrated in the cavities, which is not shown in FIG. 1 for the sake of simplicity.

The fluoroalkyl-containing cooligomer (5) forms an aggregate in a solvent. FIG. 2 illustrates a schematic view of an aggregate of the fluoroalkyl-containing cooligomer (5). In FIG. 2, fluoroalkyl-containing cooligomer molecules 26, each having hydrophobic groups R¹ and R² at their respective terminals, are bonded to each other through the intermolecular forces 27 between R¹s and between R²s in a solvent to form an aggregate 28. The number of the fluoroalkyl-containing cooligomer molecules 26 forming one aggregate 28 is about 10 to 1000. In fact, an ionic liquid exists around the fluoroalkyl-containing cooligomer molecules 26, which is not described in FIG. 2 for the sake of simplicity.

Since the fluoroalkyl-containing cooligomer (5) forms the aggregate 28 shown in FIG. 2, the reaction between the isocyanate groups of the fluoroalkyl-containing cooligomer molecules (5) produces the three-dimensional structure 21 illustrated in FIG. 1.

Since the fluoroalkyl-containing cooligomer (5) has a plurality of isocyanate groups per molecule, the isocyanate groups of the same molecule can react with each other. However, since the fluoroalkyl-containing cooligomer molecules (5) are present in the form of an aggregate 28 in a solvent as illustrated in FIG. 2, and since the isocyanate groups of the same molecule cannot react with each other without being accompanied by considerable deformation of the molecular chain, the isocyanate groups of a molecule of the fluoroalkyl-containing cooligomer (5) react with the isocyanate groups of other molecules more easily than with those of the same molecule.

In the crosslinking step, the reaction between the isocyanate groups of the fluoroalkyl-containing cooligomer (5) is carried out in the presence of an ionic liquid (7). Therefore, the three-dimensional crosslinked structure is formed while enclathrating the ionic liquid (7) in its cavities, thereby to produce the three-dimensionally crosslinked clathrate particle.

The three-dimensionally crosslinked clathrate particle obtained by the crosslinking step will be illustrated by way of FIG. 3. FIG. 3 is a schematic view of a powdery three-dimensionally crosslinked clathrate particle of the invention. A three-dimensionally crosslinked clathrate particle 30 illustrated in FIG. 3 comprises a three-dimensional crosslinked structure 21 and an ionic liquid 25 enclathrated in the structure 21. Specifically, the ionic liquid 25a and 25b is enclathrated in the cavities 24a and 24b formed by the fluoroalkyl-containing cooligomer main chains 22a, 22b, and 22c and the crosslinkages 23a, 23b, 23c, and 23d.

After the crosslinking step, the resulting three-dimensionally crosslinked clathrate particles (8) are separated from the reaction system by, e.g., filtration or centrifugation, to give the powdery three-dimensionally crosslinked clathrate particles of the first embodiment of the invention.

In general formula (1) representing the fluoroalkanoyl peroxide compound used in the first-order polymerization step, R¹ and R² each represent a —(CF₂)ₚ—X group or a —CF(CF₃)—[OCF₂CF(CF₃)]_{q}—OC₃F₇ group. R¹ and R² may be the same or different. X in R¹ and R² represents a hydrogen atom, a fluorine atom or a chlorine atom. p and q each represent an integer of 0 to 10, preferably 0 to 8, more preferably 0 to 5.

Examples of the fluoroalkanoyl peroxide compound of general formula (1) include diperfluoro-2-methyl-3-oxahexanoyl peroxide, diperfluoro-2,5-dimethyl-3,6-dioxanonanoyl peroxide, diperfluoro-2,5,8-trimethyl-3,6,9-trioxadodecanoyl peroxide, diperfluorobutyryl peroxide, diperfluoroheptanoyl peroxide, and diperfluorooctanoyl peroxide. The fluoroalkanoyl peroxide compounds of general formula (1) are easily obtainable by known processes, for example, by causing hydrogen peroxide to react with a fluoroalkyl-containing acyl halide in a fluorine-containing aromatic solvent or a fluorine-containing aliphatic solvent (e.g., a CFC's substitute) in the presence of an alkali such as sodium hydroxide, potassium hydroxide, potassium hydrogencarbonate, sodium carbonate, or potassium carbonate.

In general formula (2) representing the monofunctional monomer used in the first-order polymerization step, Z represents a hydroxyl group, a morpholino group, a tertiary amino group, or a secondary amino group. The tertiary amino group as Z is exemplified by a trimethylamino group and a triethylamino group, and the secondary amino group as Z is exemplified by a —NHC(CH₃)₂CH₂COCH₃ group and a —NHCH(CH₃)₂ group.

The polyfunctional monomer having an olefinic double bond and an isocyanate group that can be used in the first-order polymerization step is a compound having an olefinic double bond (carbon-carbon double bond) and an isocyanate group (—NCO) per molecule. Examples of such a polyfunctional monomer include 2-isocyanatoethyl acrylate and 2-isocyanatoethyl methacrylate.

The first-order polymerization step is effected by reacting the fluoroalkanoyl peroxide compound of general formula (1), the monofunctional monomer of general formula (2), and the polyfunctional monomer having an olefinic double bond and an isocyanate group with one another to provide a fluoroalkyl-containing cooligomer.

The reaction of the first-order polymerization step is a copolymerization reaction carried out through the substeps of mixing the fluoroalkanoyl peroxide compound of general formula (1), the monofunctional monomer of general formula (2), and the polyfunctional monomer having an olefinic double bond and an isocyanate group in a solvent, heating the reaction system to induce polymerization, and continuing the heating for a given period of time.

The solvent that can be used in the first-order polymerization step is selected as appropriate according to the dissolving capabilities. Examples of preferred solvents are AK-225 (incombustible, fluorocarbon solvent mixture represented by CF₃CF₂CHCl₂/CClF₂CF₂CHClF, available from Asahi Glass Co., Ltd) and perfluorohexane.

The ratio of mixing the fluoroalkanoyl peroxide compound of general formula (1), the monofunctional monomer of general formula (2), and the polyfunctional monomer having an olefinic double bond and an isocyanate group is not particularly limited and decided appropriately. The monofunctional monomer of general formula (2) is preferably used in an amount of 0.1 to 50 mol. more preferably 0.5 to 20 mol. per mole of the fluoroalkanoyl peroxide compound of general formula (1). The polyfunctional monomer having an olefinic double bond and an isocyanate group is preferably used in an amount of 0.1 to 50 mol. more preferably 0.5 to 20 mol. per mole of the fluoroalkanoyl peroxide compound of general formula (1). The amount of the polyfunctional monomer having an olefinic double bond and an isocyanate group is preferably 1 to 50 mol. more preferably 1 to 10 mol. per mole of the monofunctional monomer of general formula (2).

The copolymerization reaction in the first-order polymerization step is carried out at a temperature of 0° C. to 70° C., preferably 10° C. to 60° C., for a period of 0.5 to 10 hours, preferably 1 to 5 hours. The copolymerization reaction of the first-order polymerization step is preferably performed in an inert gas atmosphere, such as a nitrogen, helium or argon atmosphere, for achieving a higher yield.

The fluoroalkyl-containing cooligomer obtained by the first-order polymerization step has a copolymer main chain comprising the monofunctional monomer of general formula (2) and the polyfunctional monomer having an olefinic double bond and an isocyanate group and has R¹ and R² of general formula (1) at the terminals thereof. The main chain of the fluoroalkyl-containing cooligomer has bonded thereto Z group of general formula (2) and an isocyanate group.

The reaction solution resulting from the first-order polymerization step, i.e., the reaction solution having the fluoroalkyl-containing cooligomer dissolved therein is subjected to the subsequent step either as it is or after the solvent is removed therefrom.

The ionic liquid used in the crosslinking step is a salt that consists of a cation and an anion, is liquid at ambient temperature (25° C.) and ambient pressure (0.1 MPa), and has no boiling point. Any substances that satisfy the above characteristics can be used, including imidazolium salts, alkylpyridinium salts, alkylammonium salts, and phosphonium salts. Preferred of them are phosphonium salts in terms of providing powdery three-dimensionally crosslinked clathrate particles having high antistatic properties or antimicrobial properties. Particularly preferred are the phosphonium salts represented by general formula (3) which exhibit the character of an ionic liquid, i.e., which is liquid at ambient temperature and pressure. The phosphonium salt may be a commercially available product or may be synthesized by known processes. That is, a phosphonium salt halide is synthesized from a trialkylphosphine and an alkyl halide, e.g., an alkyl chloride, and a desired phosphonium salt is obtained by replacing the anion of the phosphonium halide by double decomposition.

The crosslinking step starts with mixing the fluoroalkyl-containing cooligomer obtained in the first-order polymerization step and an ionic liquid to prepare a mixture of the fluoroalkyl-containing cooligomer and the ionic liquid.

The mixing of the fluoroalkyl-containing cooligomer and the ionic liquid may be effected by putting the fluoroalkyl-containing cooligomer and the ionic liquid into a solvent or by adding the ionic liquid and, if desired, a solvent to the reaction solution as obtained in the first-order polymerization step.

The solvent that can be used in the crosslinking step is selected as appropriate according to the dissolving capabilities. Examples of preferred solvents are AK-225 and perfluorohexane.

The amount of the ionic liquid to be added is 0.1 to 100 g, preferably 0.5 to 50 g, per gram of the polyfunctional monomer having an olefinic double bond and an isocyanate group that has been mixed in the first-order polymerization step.

The fluoroalkyl-containing cooligomer is then crosslinked with itself at the isocyanate groups thereof in the presence of the ionic liquid to produce three-dimensionally crosslinked clathrate particles.

The reaction between the isocyanate groups of the fluoroalkyl-containing cooligomer in the presence of the ionic liquid is performed by, for example, adding to the fluoroalkyl-containing cooligomer/ionic liquid mixture water and a solvent capable of dissolving water, such as ethylene glycol, followed by stirring. The reaction between the isocyanate groups of the fluoroalkyl-containing cooligomer in the presence of the ionic liquid is carried out at a temperature of −5° C. to 100° C., preferably 20° C. to 70° C., for a period of 0.5 to 10 hours, preferably 1 to 5 hours. The reaction between the isocyanate groups of the fluoroalkyl-containing cooligomer in the presence of the ionic liquid is preferably conducted in an inert gas atmosphere.

Being insoluble in both an organic solvent and water, the three-dimensionally crosslinked clathrate particle as obtained by the crosslinking step can be separated from the liquid phase by, for example, filtration or centrifugation to yield the powdery three-dimensionally crosslinked clathrate particles according to the first embodiment of the invention.

The powdery three-dimensionally crosslinked clathrate particles of the first embodiment of the invention have an average particle size of 5 to 900 nm, preferably 10 to 700 nm. The average particle size as referred to in the present invention is measured with a dynamic light scattering particle size analyzer.

The inclusion of an ionic liquid in the powdery three-dimensionally crosslinked clathrate particle of the first embodiment can be confirmed by detecting an atom derived only from the ionic liquid by ICP-AES. The content of the ionic liquid in the powdery three-dimensionally crosslinked clathrate particle is calculated from the content of the atom derived only from the ionic liquid as determined by ICP-AES. The atom derived only from the ionic liquid may be of either the anion or the cation constituting the ionic liquid.

The existence of the groups R¹ and R² in the powdery three-dimensionally crosslinked clathrate particle of the first embodiment of the invention can be confirmed by detecting a fluorine atom by elemental analysis. The fluorine content in the powdery three-dimensionally crosslinked clathrate particle of the first embodiment of the invention is calculated from the fluorine atom content measured by elemental analysis.

A second embodiment of the powdery particle of a three-dimensionally crosslinked clathrate (hereinafter referred to as a powdery three-dimensionally crosslinked clathrate particle) according to the invention is a particle obtained by a process including a first-order polymerization step and a crosslinking step. The first-order polymerization step is a step of reacting a fluoroalkanoyl peroxide compound represented by general formula (1), a monofunctional monomer represented by general formula (2), and a polyfunctional monomer having an olefinic double bond and an isocyanate group with one another to obtain a fluoroalkyl-containing cooligomer. The crosslinking step includes the substeps of mixing the fluoroalkyl-containing cooligomer with a phosphonium salt represented by general formula (3) and causing the cooligomer to react with itself at the isocyanate groups thereof in the presence of the phosphonium salt of general formula (3) to obtain a three-dimensionally crosslinked clathrate in the form of powdery particles.

The difference between the first and second embodiments of the powdery three-dimensionally crosslinked clathrate particles consists in that the substance mixed in the crosslinking step is an ionic liquid in the former and a phosphonium salt of general formula (3) in the latter.

In general formula (3) representing the phosphonium salt, R³, R⁴, R⁵, and R⁶ each represent a straight-chain or branched alkyl group having 1 to 18 carbon atoms, a cycloalkyl group, or a phenyl group. R³, R⁴, R⁵, and R⁶ may be the same or different. Y represents an anion group. Examples of Y⁻ include a fluorine ion, a chloride ion, a bromine ion, an iodine ion, BF₄⁻, PF₆⁻, N(SO₂CF₃)₂⁻, PO₂(OMe)₂⁻, PS₂(OEt)₂⁻, and (CO₂Me)₂PhSO₃⁻. The anion groups enumerated above are preferred in terms of ease of the preparation of the phosphonium salt.

In the production of the second embodiment of the powdery three-dimensionally crosslinked clathrate particle of the invention, the amount of the phosphonium salt of general formula (3) to be added in the crosslinking step is 0.1 to 100 g, preferably 0.5 to 50 g, per gram of the polyfunctional monomer having an olefinic double bond and an isocyanate group that has been mixed in the first-order polymerization step.

The fluoroalkanoyl peroxide compound of general formula (1), the monofunctional monomer of general formula (2), the polyfunctional monomer having an olefinic double bond and an isocyanate group, the fluoroalkyl-containing cooligomer, the first-order polymerization step, the reaction between isocyanate groups of the fluoroalkyl-containing cooligomer, the three-dimensional crosslinked structure, the crosslinking step, and the powdery three-dimensionally crosslinked clathrate particle that concern the second embodiment of the powdery three-dimensionally crosslinked clathrate particle are the same as those concerning the first embodiment, except that the phosphonium salt of general formula (3) is used in the former in place of the ionic liquid used in the latter.

The powdery three-dimensionally crosslinked clathrate particles of the second embodiment of the invention have an average particle size of 5 to 900 nm, preferably 10 to 700 nm.

The inclusion of a phosphonium salt of general formula (3) in the powdery three-dimensionally crosslinked clathrate particle of the second embodiment can be confirmed by detecting a phosphorus atom by ICP-AES. The content of the phosphonium salt of general formula (3) in the powdery three-dimensionally crosslinked clathrate particle of the second embodiment is calculated from the phosphorus content determined by ICP-AES.

The existence of the groups R¹ and R² in the powdery three-dimensionally crosslinked clathrate particle of the second embodiment of the invention can be confirmed by detecting a fluorine atom by elemental analysis. The fluorine content in the powdery three-dimensionally crosslinked clathrate particle of the second embodiment of the invention is calculated from the fluorine atom content measured by elemental analysis.

The process of producing a powdery three-dimensionally crosslinked clathrate particle of the first embodiment includes the first-order polymerization step and the crosslinking step described with respect to the powdery three-dimensionally crosslinked clathrate particle of the first embodiment. The process of producing a powdery three-dimensionally crosslinked clathrate particle of the second embodiment includes the first-order polymerization step and the crosslinking step described with respect to the powdery three-dimensionally crosslinked clathrate particle of the second embodiment.

The dispersion according to the present invention includes a solvent and the powdery three-dimensionally crosslinked clathrate particle of the first or second embodiment of the invention dispersed in the solvent. The powdery three-dimensionally crosslinked clathrate particles of the first or second embodiment may be of a single kind or a combination of two or more kinds.

The solvent that is used in the dispersion of the invention may be water or an organic solvent. The organic solvent may be either polar or non-polar. Examples of the organic solvent include polar solvents such as methanol, ethanol, and isopropyl alcohol and non-polar solvents such as hexane.

The dispersion of the invention is prepared by putting the powdery three-dimensionally crosslinked clathrate particles of the first or second embodiment of the invention into a solvent of choice and dispersed therein by, for example, stirring.

The resin composition according to the invention contains the powdery three-dimensionally crosslinked clathrate particles of the first or second embodiment of the invention. In other words, the resin composition of the invention includes a resin and the powdery three-dimensionally crosslinked clathrate particles of the first or second embodiment of the invention dispersed in the resin. The powdery three-dimensionally crosslinked clathrate particles may be of a single kind or a combination of two or more kinds.

The resin in which the powdery three-dimensionally crosslinked clathrate particles are to be dispersed is not limited and exemplified by polyethylene and polymethyl methacrylate.

The resin composition of the invention is prepared by mixing the powdery three-dimensionally crosslinked clathrate particles of the first or second embodiment of the invention with a resin of choice and dispersed by, for example, melt blending.

The powdery three-dimensionally crosslinked clathrate particle of the first or second embodiment of the invention is able to impart water repellency to the resin surface by the action of the fluorine-containing groups R¹ and R². The powdery three-dimensionally crosslinked clathrate particle of the first or second embodiment of the invention therefore can be used as a resin modifier containing an ionic liquid or a phosphonium salt of general formula (3).

It is difficult to totally uniformly disperse an ionic liquid as a liquid in various solvents or resin materials. If an ionic liquid is dispersed as it is, the resulting dispersion tends to suffer from non-uniformity. Furthermore, the individual droplets of an ionic liquid as dispersed in various solvents or resin materials have a large volume because of the difficulty in reducing the droplet size. Therefore, when a solvent or a resin material having ionic liquid droplets dispersed therein is observed in small units, there is noticeable non-uniformity in amount of the ionic liquid among the units. That is, dispersions of an ionic liquid per se in various solvents or resin materials suffer from considerable non-uniformity as observed both totally and locally.

According to the present invention, in contrast, the powdery three-dimensionally crosslinked clathrate particles of the first embodiment of the invention are easily dispersible because they are solid particles having the ionic liquid enclathrated therein as compared with when the ionic liquid is dispersed in the form of a liquid. That is, using the powdery three-dimensionally crosslinked clathrate particle of the first embodiment of the invention achieves improved total dispersibility of the ionic liquid in various solvents or resin materials. Since the particle size of the powdery three-dimensionally crosslinked clathrate particle of the first embodiment of the invention is extremely as small as 5 to 900 nm, the ionic liquid can be dispersed more uniformly as observed in small units than when the ionic liquid is dispersed as it is. In short, the powdery three-dimensionally crosslinked clathrate particles of the first embodiment of the invention enable finely and uniformly dispersing an ionic liquid to provide an ionic liquid dispersion with little non-uniformity as observed either totally or locally.

Being liquid, an ionic liquid is instable in various solvents or resin materials. After dispersed in a solvent or a resin material, the dispersed droplets of the ionic liquid gather into a greater droplet. That is, the non-uniformity of a dispersion of an ionic liquid per se in a solvent or a resin material aggravates with time.

In contrast, the powdery three-dimensionally crosslinked clathrate particles of the first embodiment of the invention are less liable to agglomerate after being dispersed in a solvent or a resin material by the action of the R¹ and R² groups in general formula (1). To be brief, the powdery three-dimensionally crosslinked clathrate particles of the first embodiment of the invention exhibit good dispersibility and high dispersion stability.

The same observation is equally true of the dispersibility of the phosphonium salt of general formula (3) which is liquid at ambient temperature and pressure. In brief, the powdery three-dimensionally crosslinked clathrate particles of the second embodiment of the invention enable finely and uniformly dispersing a phosphonium salt of general formula (3) which is liquid at ambient temperature and pressure in various solvents or resin materials to provide phosphonium salt dispersions with little non-uniformity as observed either totally or locally as compared with when the phosphonium salt is dispersed as it is liquid in various solvents or resin materials, and the powdery three-dimensionally crosslinked clathrate particles of the second embodiment of the invention exhibit high dispersion stability as well as good dispersibility.

The phosphonium salt of general formula (3) which is solid at ambient temperature and pressure is, in general, not only difficult to reduce into fine particles but also liable to agglomerate in a dispersion. Therefore, when it is dispersed in various solvents or resin materials, the resulting dispersions tend to suffer from non-uniformity.

In contrast, the powdery three-dimensionally crosslinked clathrate particles according to the second embodiment of the invention enable finely and uniformly dispersing a phosphonium salt to provide a phosphonium salt dispersion with little non-uniformity as observed either totally or locally, and the powdery three-dimensionally crosslinked clathrate particles of the second embodiment exhibit high dispersion stability as well as good dispersibility.

Thus, a material having an ionic liquid or a phosphonium salt of general formula (3) finely and uniformly dispersed therein can be obtained by using the powdery three-dimensionally crosslinked clathrate particles of the second embodiment.

Since the phosphonium salt of general formula (3) has antistatic properties and antimicrobial properties and so on, functional materials having antistatic properties and antimicrobial properties can be provided by using the powdery three-dimensionally crosslinked clathrate particles of the second embodiment.

The present invention will now be illustrated in greater detail with reference to Examples, but it should be understood that they are for illustrative purposes only but not for limiting the invention.

### EXAMPLES

### Example 1

### Preparation of Three-Dimensionally Crosslinked Clathrate Particles

In a 300 ml egg flask were put 200 g of AK-225 (incombustible, fluorocarbon solvent mixture represented by CF₃CF₂CHCl₂/CClF₂CF₂CHClF, available from Asahi Glass Co., Ltd.) as a solvent, 2.38 mmol of perfluoro-2-methyl-3-oxahexanoyl peroxide ([C₃F₇—O—CF(CF₃)—CO—O—]₂), 2.38 mmol of 2-isocyanatoethyl acrylate, and 14.3 mmol of diacetonacrylamide, and the mixture was stirred at 45° C. for 1.5 hours in a nitrogen atmosphere to conduct polymerization. A solution of 1.0 g of an ionic liquid represented by chemical formula (14):

[(C₄H₉)₃P(C₈H₁₇)]⁺(CF₃SO₂)₂N⁻ (14)

in 10 g of AK-225 was added to the reaction mixture, followed by stirring for 5 minutes. Then, 98 ml of water and 2 ml of ethylene glycol were added thereto, followed by stirring at 45° C. for 2 hours in a nitrogen atmosphere. After the 2 hour stirring, the stirring was stopped, and the reaction system was allowed to stand still, whereby the reaction system separated into an AK-225 layer, a layer of particles, and an aqueous layer. The solid matter was separated from the reaction system by centrifugation. The operation of dispersing the solid in AK-225, followed by centrifugation was repeated twice. The thus purified solid was dried in vacuo in a vacuum desiccator to obtain powdery three-dimensionally crosslinked clathrate particles. The phosphorus content in the powdery three-dimensionally crosslinked clathrate particles was measured with an ICP-AES. The fluorine content of the powdery three-dimensionally crosslinked clathrate particles was measured with an elemental analyzer. The resulting powdery three-dimensionally crosslinked clathrate particles were dispersed in methanol by stirring for 24 hours to prepare a sample (A). The average dispersed particle size in the sample (A) was measured with a light scattering photometer. As a result, the yield was 47.2 mass %, the P content was 1.2 mass %, the F content was 14.5 mass %, and the average particle size was 10.8+±1.1 nm.

### Dispersibility Test

The powdery three-dimensionally crosslinked clathrate particles were tested for dispersibility in accordance with the following procedures.

### Test 1:

After the average dispersed particle size of the sample (A) was measured, the particles were collected from the sample (A) by centrifugation and dried in vacuo to remove methanol. The particles were dispersed in tetrahydrofuran (THE) by stirring for 24 hours to prepare a sample (B). The average dispersed particle size of the sample (B) was measured and found to be 10.8±1.1 nm.

### Test 2:

After the measurement of average dispersed particle size in test 1, the sample (B) was centrifuged and dried in vacuo to remove THF. 1,2-Dichloroethane was added thereto, followed by stirring for 24 hours to disperse the particles to prepare a sample (C). The average dispersed particle size of the sample (C) was measured and found to be 10.4±0.7 nm.

### Test 3:

After the measurement of average dispersed particle size in test 2, the sample (C) was centrifuged and dried in vacuo to remove 1,2-dichloroethane. AK-225 was added thereto, followed by stirring for 24 hours to disperse the particles in AK-225 to prepare a sample (D). The average dispersed particle size of the sample (D) was measured and found to be 10.8±1.5 nm.

### Example 2

### Preparation of Three-Dimensionally Crosslinked Clathrate Particles

Powdery three-dimensionally crosslinked clathrate particles were obtained in the same manner as in Example 1, except for replacing 2.38 mmol of perfluoro-2-methyl-3-oxahexanoyl peroxide, 2.38 mmol of 2-isocyanatoethyl acrylate, and 14.3 mmol of diacetonacrylamide with 2.38 mmol of perfluoro-2-methyl-3-oxahexanoyl peroxide, 7.14 mmol of 2-isocyanatoethyl acrylate, and 11.9 mmol of diacetonacrylamide. The fluorine content of the powdery three-dimensionally crosslinked clathrate particles was measured with an elemental analyzer. The resulting powdery three-dimensionally crosslinked clathrate particles were dispersed in methanol by stirring for 24 hours to prepare a sample (A). The average dispersed particle size in the sample (A) was measured with a light scattering photometer. As a result, the yield was 11.6 mass %, the F content was 19.4 mass %, and the average particle size was 78.7±13.8 nm. A TEM image of the powdery three-dimensionally crosslinked clathrate particles is shown in FIG. 4.

### Dispersibility Test

The powdery three-dimensionally crosslinked clathrate particles were tested for dispersibility in accordance with the following procedures.

### Test 1:

After the average dispersed particle size of the sample (A) was measured, the sample (A) was centrifuged and dried in vacuo to remove methanol. The particles were dispersed in tetrahydrofuran (THF) by stirring for 24 hours to prepare a sample (B). The average dispersed particle size of the sample (B) was measured and found to be 141±24.4 nm.

### Test 2:

After the measurement of average dispersed particle size in test 1, the sample (B) was centrifuged and dried in vacuo to remove THF. AK-225 was added thereto, followed by stirring for 24 hours to disperse the particles in AK-225 to prepare a sample (C). The average dispersed particle size of the sample (C) was measured and found to be 78.1±14.4 nm.

### Example 3

### Preparation of Three-Dimensionally Crosslinked Clathrate Particles

In a 300 ml egg flask were put 200 g of AK-225 as a solvent, 2.38 mmol of perfluoro-2-methyl-3-oxahexanoyl peroxide, 11.9 mmol of 2-isocyanatoethyl acrylate, and 11.9 mmol of N,N-dimethylacrylamide, and the mixture was stirred at 45° C. for 1.5 hours in a nitrogen atmosphere to conduct polymerization. A solution of 1.0 g of an ionic liquid represented by chemical formula (14) shown supra in 10 g of AK-225 was added to the reaction mixture, followed by stirring for 5 minutes. Then, 98 ml of water and 2 ml of ethylene glycol were added thereto, followed by stirring at 45° C. for 2 hours in a nitrogen atmosphere. After the 2 hour stirring, the reaction system was allowed to stand still, whereby the reaction system separated into an AK-225 layer, a layer of particles, and an aqueous layer. The solid matter was separated from the reaction system by centrifugation. The operation of dispersing the solid in AK-225, followed by centrifugation was repeated twice. The thus purified solid was dried in vacuo in a vacuum desiccator to obtain powdery three-dimensionally crosslinked clathrate particles. The fluorine content of the powdery three-dimensionally crosslinked clathrate particles was measured with an elemental analyzer. The powdery three-dimensionally crosslinked clathrate particles were dispersed in methanol by stirring for 24 hours to prepare a sample (A). The average dispersed particle size in the sample (A) was measured with a light scattering photometer. As a result, the yield was 67.8 mass %, the F content was 16.2 mass %, and the average particle size was 52.9±10.2 nm. An SEM image and a TEM image of the powdery three-dimensionally crosslinked clathrate particles are shown in FIGS. 5 and 6, respectively.

### Dispersibility Test

The powdery three-dimensionally crosslinked clathrate particles were tested for dispersibility in accordance with the following procedures.

### Test 1:

After the average dispersed particle size of the sample (A) was measured, the sample (A) was centrifuged and dried in vacuo to remove methanol. The particles were again dispersed in methanol by stirring for 24 hours to prepare a sample (B). The average dispersed particle size of the sample (B) was measured and found to be 53.6±11.5 nm.

### Example 4

### Preparation of Three-Dimensionally Crosslinked Clathrate Particles

Powdery three-dimensionally crosslinked clathrate particles were obtained in the same manner as in Example 3, except for replacing 2.38 mmol of perfluoro-2-methyl-3-oxahexanoyl peroxide, 11.9 mmol of 2-isocyanatoethyl acrylate, and 11.9 mmol of N,N-dimethylacrylamide with 2.38 mmol of perfluoro-2-methyl-3-oxahexanoyl peroxide, 16.7 mmol of 2-isocyanatoethyl acrylate, and 11.9 mmol of N,N-dimethylacrylamide. The fluorine content of the powdery three-dimensionally crosslinked clathrate particles was measured with an elemental analyzer. The powdery three-dimensionally crosslinked clathrate particles were dispersed in methanol by stirring for 24 hours to prepare a sample (A). The average dispersed particle size in the sample (A) was measured with a light scattering photometer. As a result, the yield was 71.2 mass %, the F content was 16.5 mass %, and the average particle size was 53.1±19.1 nm.

### Dispersibility Test

The powdery three-dimensionally crosslinked clathrate particles were tested for dispersibility in accordance with the following procedures.

### Test 1:

After the average dispersed particle size of the sample (A) was measured, the sample (A) was centrifuged and dried in vacuo to remove methanol. The particles were again dispersed in methanol by stirring for 24 hours to prepare a sample (B). The average dispersed particle size of the sample (B) was measured and found to be 171.4±42.4 nm. The analyzers and methods of analysis used in Examples were as follows.

(a) ICP-AES: ICP-AES JY170C ULTRACE available from Horiba, Ltd.; measuring wavelength: 214.914 nm (emission line of P atom)
(b) Measurement of average particle size: DLS-6000BL available from Otsuka Electronics Co., Ltd.; dynamic light scattering method

### INDUSTRIAL APPLICABILITY

The powdery three-dimensionally crosslinked clathrate particles of the present invention provide functional materials having an ionic liquid or a phosphonium salt of general formula (3) finely and uniformly dispersed therein.

### BRIEF DESCRIPTION OF THE DRAWINGS

FIG. 1 is a schematic illustration of a three-dimensional crosslinked structure pertinent to the powdery three-dimensionally crosslinked clathrate particle according to the first embodiment of the invention.

FIG. 2 is a schematic illustration of an aggregate of molecules of a fluoroalkyl-containing cooligomer (5).

FIG. 3 is a schematic illustration of a powdery three-dimensionally crosslinked clathrate particle according to the invention.

FIG. 4 is a TEM image of the powdery three-dimensionally crosslinked clathrate particles of Example 2.

FIG. 5 is an SEM image of the powdery three-dimensionally crosslinked clathrate particles of Example 3.

FIG. 6 is a TEM image of the powdery three-dimensionally crosslinked clathrate particles of Example 3.

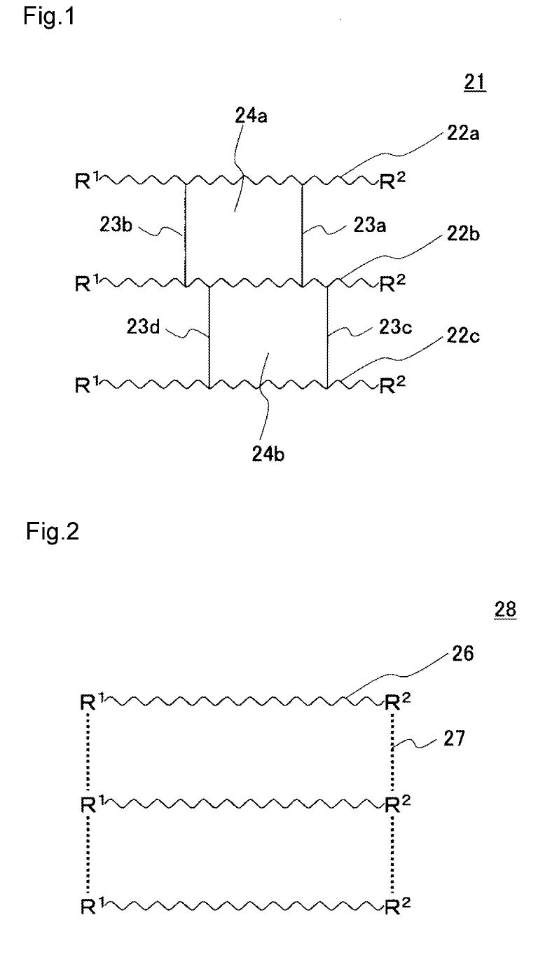

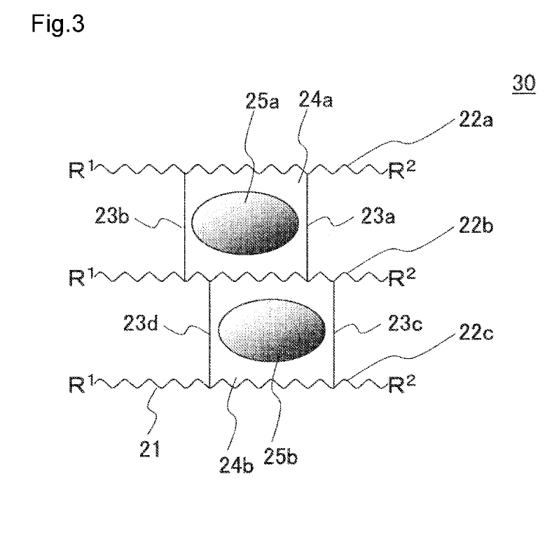

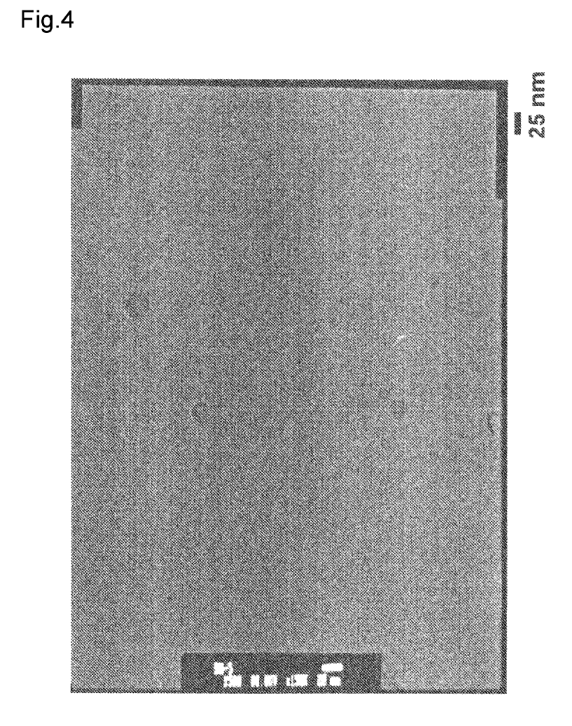

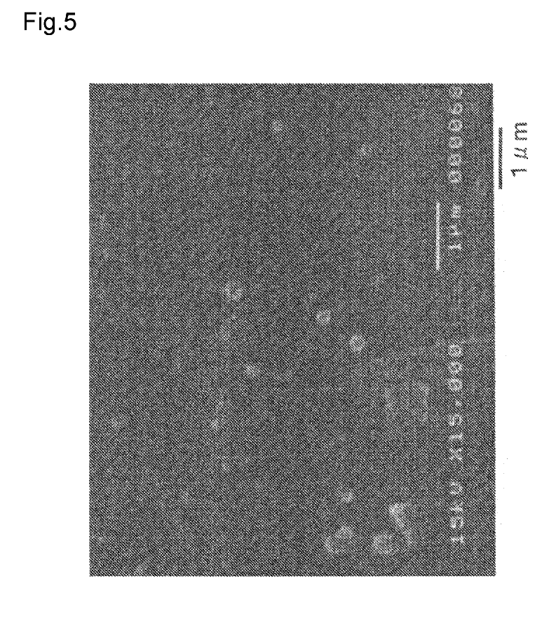

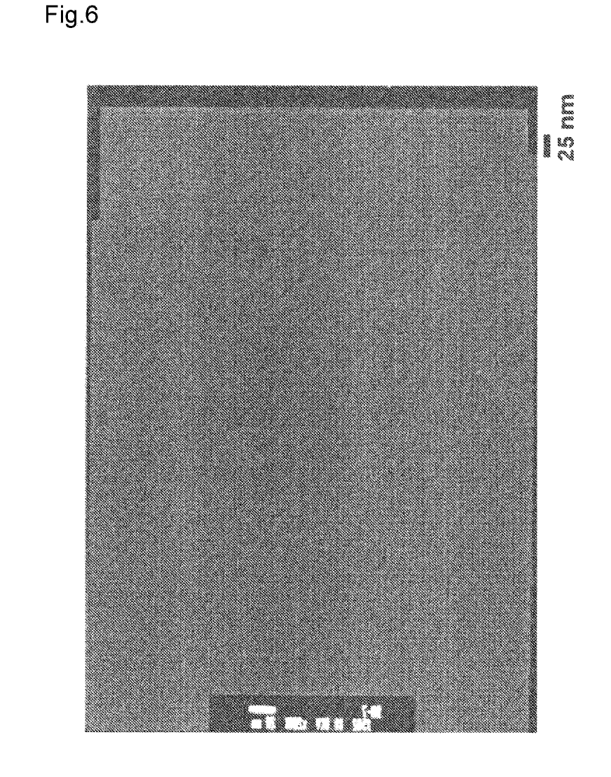

### DESCRIPTION OF REFERENCE NUMERALS

21 Three-dimensional crosslinked structure
22 Fluoroalkyl-containing cooligomer main chain
23 Crosslinkage
24 Cavity
25 Ionic liquid
26 Fluoroalkyl-containing cooligomer molecule
27 Intermolecular force
28 Aggregate
30 Three-dimensionally crosslinked clathrate particle

1. A powdery particle of a three-dimensionally crosslinked clathrate obtained by a process comprising:
a first-order polymerization step in which a fluoroalkanoyl peroxide compound represented by general formula (1): 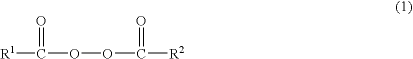
(wherein R¹ and R², which may be the same or different, each represent a —(CF₂)ₚ—X group or a —CF(CF₃)—[OCF₂CF(CF₃)]_{q}—OC₃F₇ group; X represents a hydrogen atom, a fluorine atom, or a chlorine atom; and p and q each represent an integer of 0 to 10)
a monofunctional monomer represented by general formula (2): 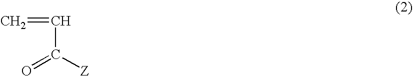
(wherein Z represents a hydroxyl group, a morpholino group, a tertiary amino group, Z or a secondary amino group)
and a polyfunctional monomer having an olefinic double bond and an isocyanate group are reacted with one another to obtain a fluoroalkyl-containing cooligomer; and
a crosslinking step comprising the substeps of mixing the fluoroalkyl-containing cooligomer and an ionic liquid and causing the cooligomer to react with itself at the isocyanate groups thereof in the presence of the ionic liquid to obtain a powdery particle of a three-dimensionally crosslinked clathrate.

2. A powdery particle of a three-dimensionally crosslinked clathrate obtained by a process comprising:
a first-order polymerization step in which a fluoroalkanoyl peroxide compound represented by general formula (1): 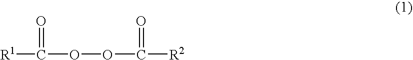
(wherein R¹ and R², which may be the same or different, each represent a —(CF₂)ₚ—X group or a —CF(CF₃)—[OCF₂CF(CF₃)]_{q}—OC₃F₇ group; X represents a hydrogen atom, a fluorine atom, or a chlorine atom; and p and q each represents an integer of 0 to 10)
a monofunctional monomer represented by general formula (2): 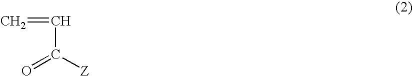
(wherein Z represents a hydroxyl group, a morpholino group, a tertiary amino group, or a secondary amino group)
and a polyfunctional monomer having an olefinic double bond and an isocyanate group are reacted with one another to obtain a fluoroalkyl-containing cooligomer; and
a crosslinking step comprising the substeps of mixing the fluoroalkyl-containing cooligomer and a phosphonium salt represented by general formula (3): 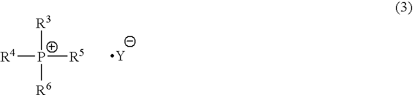
(wherein R³, R⁴, R⁵, and R⁶, which may be the same or different, each represent a straight-chain or branched alkyl group having 1 to 18 carbon atoms, a cycloalkyl group, or a phenyl group; and Y represents an anion group)
and causing the cooligomer to react with itself at the isocyanate groups thereof in the presence of the phosphonium salt represented by general formula (3) to obtain a powdery particle of a three-dimensionally crosslinked clathrate.

3. A process of producing a powdery particle of a three-dimensionally crosslinked clathrate, the process comprising:
a first-order polymerization step in which a fluoroalkanoyl peroxide compound represented by general formula (1): 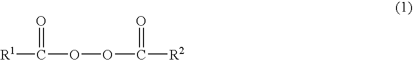
(wherein R¹ and R², which may be the same or different, each represent a —(CF₂)ₚ—X group or a —CF(CF₃)—[OCF₂CF(CF₃)]_{q}—OC₃F₇ group; X represents a hydrogen atom, a fluorine atom, or a chlorine atom; and p and q each represent an integer of 0 to 10)
a monofunctional monomer represented by general formula (2): 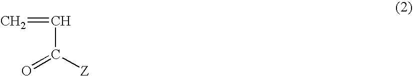
(wherein Z represents a hydroxyl group, a morpholino group, a tertiary amino group, or a secondary amino group)
and a polyfunctional monomer having an olefinic double bond and an isocyanate group are reacted with one another to obtain a fluoroalkyl-containing cooligomer; and
a crosslinking step comprising the substeps of mixing the fluoroalkyl-containing cooligomer and an ionic liquid and causing the cooligomer to react with itself at the isocyanate groups thereof in the presence of the ionic liquid to obtain a powdery particle of a three-dimensionally crosslinked clathrate.

4. A process of producing a powdery particle of a three-dimensionally crosslinked clathrate, the process comprising:
a first-order polymerization step in which a fluoroalkanoyl peroxide compound represented by general formula (1): 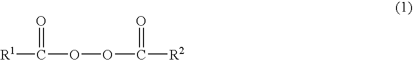
(wherein R¹ and R², which may be the same or different, each represent a —(CF₂)ₚ—X group or a —CF(CF₃)—[OCF₂CF(CF₃)]_{q}—OC₃F₇ group; X represents a hydrogen atom, a fluorine atom, or a chlorine atom; and p and q each represents an integer of 0 to 10)
a monofunctional monomer represented by general formula (2): 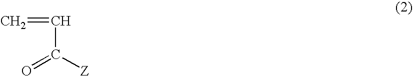
(wherein Z represents a hydroxyl group, a morpholino group, a tertiary amino group, or a secondary amino group)
and a polyfunctional monomer having an olefinic double bond and an isocyanate group are reacted with one another to obtain a fluoroalkyl-containing cooligomer; and
a crosslinking step comprising the substeps of mixing the fluoroalkyl-containing cooligomer and a phosphonium salt represented by general formula (3): 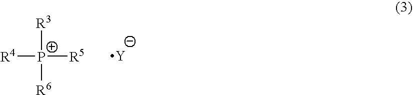
(wherein R³, R⁴, R⁵, and R⁶, which may be the same or different, each represent a straight-chain or branched alkyl group having 1 to 18 carbon atoms, a cycloalkyl group, or a phenyl group; and Y represents an anion group)
and causing the cooligomer to react with itself at the isocyanate groups thereof in the presence of the phosphonium salt represented by general formula (3) to obtain a powdery particle of a three-dimensionally crosslinked clathrate.

5. A dispersion comprising a solvent and the powdery particle of a three-dimensionally crosslinked clathrate according to claim 1 or 2 dispersed in the solvent.

6. A resin composition containing the powdery particle of a three-dimensionally crosslinked clathrate according to claim 1 or 2.
